(19) United States
(12) Patent Application Publication
(10) Pub. No.: US 2004/0139411 A1
(43) Pub. Date: Jul. 15, 2004

(54) Heterogenous design process and apparatus for systems employing static design components and programmable gate array sub-array areas

(76) Inventors: Winthrop W. Smith, Richardson, TX (US); Harold Keith Seawrigjt, Colleyville, TX (US)

Correspondence Address: Robert H. Frantz, P.O Box 23324, Oklahoma City, OK, 73123, US

(21) Appl. No.: 10/341,177

(22) Filed: Jan. 13, 2003

(51) Int. Cl. G06F 17/50

(52) U.S. Cl. 716/7

(57) ABSTRACT

A method for heterogeneous design and implementation of a complex electronic and software system having one or more static components and one or more programmable logic components in which a first programmable gate array area is provided with a first area having definable function blocks and routable interconnects, a first program for the first area is established and dedicated to a first logic design having a first set of functionality and interconnects, and a second programmable gate array area located within the first area is established, with the second area having definable function blocks and routable interconnects with resources and constraints formed by said first logic design. The logical and performance characteristics of the first area are established and frozen such that a high-level system tool may utilize and analyze a system design containing the first design in the gate sub-array as if it were a static design component.

### CROSS-REFERENCE TO RELATED APPLICATIONS

### (CLAIMING BENEFIT UNDER 35 U.S.C. 120)

Not applicable.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

Not applicable.

### BACKGROUND OF THE INVENTION

1. Field of the Invention

This invention relates to the arts of system-level design processes for electronics and software systems, and especially to the arts of design tools and apparatuses which enable high level design, integration and analysis of systems which incorporate field programmable logic.

2. Description of the Related Art

There are several different design methodologies for complex programmable logic devices such as Field Programmable Gate Arrays (“FGPA”), Configurable Programmable Logic Devices (“CPLD”), and the like. In one well known method, a design is developed using a schematic entry tool, with each needed logic function in the design being represented graphically by a circuit symbol. To yield a program or “mask” for the programmable logic device, the user completes entry of a schematic, “compiles” the design, “routes and places” the design for the intended target device, and then receives from a design tool a binary file which can be loaded into a “blank” or unprogrammed device in order for the device to perform the logic functions of the design.

Some tools allow certain levels of simulation of the design, both in logic and timing, prior to programming the device. A designer may iterate the design-compile-stimulate cycle several times before a design is yielded which may be testable on the device.

Likewise, a designer may iterate a design-compile-route_and_place-program-test cycle multiple times before a final design is achieved. In some iterations, design changes may cause the design to be unplaceable or unroutable due to physical constraints of the targeted device. The designer may target a different device with resources that meet the needs of the revised design, or he may return to the design step to look for ways to modify the design yet again to make it “fit” into the desired target device. The same scenario is often true of timing requirements, wherein final signal propagation and transfer timing is only really known after a real device is programmed and tested, although many systems attempt to provide accurate modeling and timing analysis during the design cycle to predict likely timing characteristics.

Another methodology for designing with programmable logic devices is to utilize a high level design language. Very High-level Design Language (“VHDL”) is one of the most popular languages used for such methodologies, and most programmable logic device manufacturers provide tools or compilers which implement VHDL-style programming languages and concepts. In some cases, third-party generic high-level design tools such as Synplicity, Exemplar, Mentor, OrCAD, and PrimeTime, also “support” designs which target various programmable logic devices though a combination of interfaces to or integrations of portions of proprietary manufacturer-supplied estimators, simulators, models, behavioral stubs, routers, placers, and compilers.

Using either type of high-level design tool, however, typically yields the same type of cyclical or “incremental” design process (10), as shown in FIG. 1. The initial design may be completed (11) in a High Level Design methodology such as VHDL, followed by rule checking (12) on the design. Basic rule checking looks for design guidelines (e.g. warning issues) and design constraint (e.g. failure issues) such as undefined inputs to functions, “floating” outputs, logic portions with indeterminate initial states, invalid feedback paths, race conditions, etc. If any failures or warnings are found (17) and the designer so wishes, he or she may revise (16) the high level design and perform rule checking (12). This small cycle (11, 12, 16) may be repeated several times until complete.

After design rule checking is passed or successfully completed, the designer may then simulate (13) the design, and analyze the simulation results looking for logical failures (e.g. failure to perform the correct logical function or operations) and possible timing issues at a high level. If any problems are found (17), the design may again be revised (16), rule checked (12) and simulated (13). This larger cycle (11, 12, 13, 16) may be repeated several times until complete.

Next, the designer may select a target device such as a specific make and part number of programmable device (e.g. FPGA, PLD, PAL, etc.) or even die type for ASIC designs, which will have certain resources and constraints associated with it such as external I/O count (e.g. “pin count”), internal routing connections and busses, and gate counts. In some systems, power may be a constraint, as well, as certain designs may “fit” into the allowed number of gates and may be “routable”, but may not be executable in reality due to excessive power consumption.

So, during compilation (14), shown here to include routing and placement of logic functions within the programmable array, many rules and constraints related to the specific device are checked and followed. If any are violated (14), the design may be rejected by the compiler, leading to a revision of the design (16) or targeting of an alternate device. This even longer cycle (11, 12, 13, 14, 16) may be repeated several times until compilation and production (15) of a program (e.g. a “fuse map”) is successful.

Finally, a device may be programmed in a prototype or “eval” circuit card where it can be actually operated, stimulated, measured, and tested (19). Occasionally, due to software problems in models used by compilers, placers and routers, a part may not actually be programmable with the fuse map, which may require investigation and revision of the design to avoid the software problem. Most often, however, real performance of the programmed part during testing (19) does not meet the desired characteristics of the device, either logically and/or temporally, which requires the design to be revised (16). As such, a very long cycle (11, 12, 13, 14, 15, 18, 19, 16) may be “iterated” several times before a final design is achieved (100).

Design of complex systems which include application specific chipsets, microprocessors, memory devices, programmable logic devices, bus interfaces, coprocessors, and other types of integrated circuit (“IC”) devices is often performed in a similar manner, albeit using different types of tools. VHDL was initially developed as a system design tool or language, and use for it was found in the programmable logic designer community. However, VHDL can be used with a number of high-level system design tools in which complex “fixed design” components such as microprocessors or bus controller IC's are “modeled” using elaborate VHDL descriptions. In this sense, entire programmable logic devices can be incorporated into the system level design in the early phase, as all the VHDL can be processed and simulated using the top-level VHDL design tool. However, this type of top-level or high-level design in VHDL of systems (not just programmable logic devices) has found many practical limitations with respect to processing requirements, timing analysis, and excessive unknown variables, and as such, is not widely employed for such system-level design tasks.

Graphical system design tools and methodologies, however, have been produced to provide this type of high-level system design and analysis which in many ways mimic the schematic capture approach previously described for programmable logic design development. Tools such as Graphical Entry Distributed Application Environment (GEDAE) allow system design, functional partitioning, simulation and analysis using block-level graphical techniques. For example, a circuit board may be represented by a single block, and a second circuit board to which it interfaces may be represented by another block, with various interconnections defined between them. In a lower level of hierarchy in the same design, the “inside” of the a circuit board may be represented by a block for a processor, several memory blocks, a bus interface controller block, and a programmable logic device block, for example.

Powerful high-level system design tools such as GEDAE allow for automatic and/or iterative design partitioning between resources to achieve optimal system performance, cost, power, reliability, etc. For example, an image processing system design may be partitioned with 80% of the system functionality being performed by software executed by a processor, and 20% of the system functionality being performed by application specific IC's (“ASICS”) such as a graphics acceleration chipset. In another partitioning of system functionality, a lower power processor may perform 50% of the system functionality in software/firmware, while 20% is performed by the graphics chipset, and the other 20% is performed by logic contained in a programmable logic device.

However, many of these block-level components are “fixed designs” at this level in the hierarchy. For example, although a microprocessor can execute software, no user-definable changes may be made to the actual internal arrangement, interconnection, and operation of the microprocessor's internal logic (e.g. its gate-level design is static). The programmable logic devices in the system design, then, are different from the other components in this respect, as they may be further defined within its boundaries of gate count and pin count. As such, programmable logic circuits are often employed in systems and assigned anticipated or foreseen functions, and extra programmable logic is often included in the system design to accommodate unforeseeable system functions and requirements.

Typically, though, a high-level system design tool such as GEDAE does not provide introspection into the program or internal design of programmable logic devices within the system design. Conversely, the design tools used to provide programmable logic design do not, of course, provide any knowledge or “extrospection” regarding the larger system within which the programmable logic device resides. This, then, establishes a boundary within the system design at the I/O of the programmable logic devices wherein different tools and methodologies must be employed to achieve fundamentally similar design steps.

To develop the ability to program from a high level language, a library of vector, signal and image processing functions can be defined for a sub-section of an FPGA without disturbing other functionality within the FPGA. This can be done at three levels. First, with pre-existing high level functions such as FIR Filters and FFTs. Second with a set of scalar, vector, matrix and signal processing functions. Finally, by providing a general programming environment for combining these functions with user defined functions. All of this may be provided to the user at a level that allows the user to program it into the FPGA using high level block diagram based tools.

Therefore, there is a need in the art for a system and method for integrating complex programmable logic device designs into larger system designs seamlessly and intuitively, preferably in conjunction with well-known design tool products and methodologies. It is desirable to implement higher levels of on-chip parallelism, better matching of processor complexity to function, and to avoiding on- and off-chip communication bottlenecks that currently arise in programmable logic arrays of discrete programmable processors.

### SUMMARY OF THE INVENTION

A design system and method for performing heterogeneous design and implementation of a complex electronic and software system having one or more static components and one or more programmable logic components is disclosed. According to the invention, a first programmable gate array area is provided with a first area having definable function blocks and routable interconnects, a first program for the first area is established and dedicated to a first logic design having a first set of functionality and interconnects, and a second programmable gate array area located within the first area is established, with the second area having definable function blocks and routable interconnects with resources and constraints formed by said first logic design. The logical and performance characteristics of the first area are established and frozen such that a high-level system tool may utilize and analyze a system design containing the first design in the gate sub-array as if it were a static design component.

### BRIEF DESCRIPTION OF THE DRAWINGS

The figures presented herein when taken in conjunction with the disclosure form a complete description of the invention.

FIG. 1 illustrates typical cyclical or “incremental” design processes followed by system level designers as well as programmable logic designers.

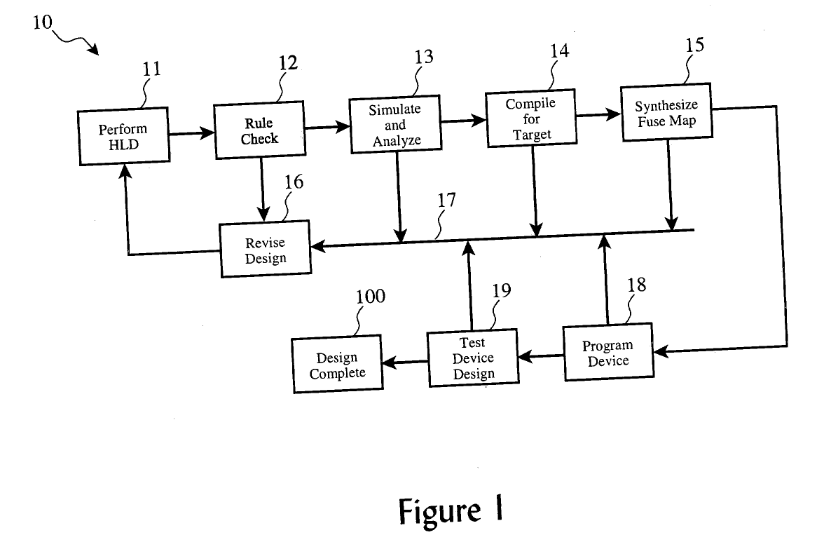

FIG. 2 shows a functional block diagram of the Tera Force Technology “EAGLE” dual-processor circuit board used in the exemplary embodiment.

FIG. 3 illustrates one manner in which the data can be made to flow through the FPGA multiple times to create a useful series processing arrangement.

FIG. 4 provides a functional block diagram of each FPGA on the EAGLE board according to an exemplary embodiment.

FIG. 5 shows a functional block diagram of the signal processing core inside each FPGA according to one aspect of the invention.

FIG. 6 depicts an example functional block diagram of an FPGA-based FFT processing architecture.

FIG. 7 provides an example functional block diagram of an FPGA-based FIR filter processing architecture using multiple Multiply-Accumulate (“MAC”) engines with individual coefficient inputs.

FIG. 8 provides more details of a MAC engine such as shown in FIG. 7.

FIG. 9 contains a graph depicting FIR filter performance as a function of the number of parallel real FIR filters implemented and the input sampling frequency is shown.

### DETAILED DESCRIPTION OF THE INVENTION

According a one possible embodiment, the present invention is realized in conjunction with and compatible with the aforementioned GEDAE [TM] system level development tool from Blue Horizon Development Software Inc. GEDAE employs a block diagram-based system level design and programming paradigm, an supports iterative high level design, simulation, and analysis, followed by low-level “synthesis” of software application code for specific target hardware, including embedded microprocessors. The present invention enables a portion or sub-array of a programmable logic device to be developed and then to be defined as a “static” processing resource available to a designer during high-level design using GEDAE. By restricting actual implementation changes to the sub-array which is pre-defined, cyclical design steps using a separate programmable logic design tool and methodology is avoided.

For example, a digital signal processing (“DSP”) resource such as a Fast Fourier Transform (“FFT”) may be implemented initially using a manufacturer-specific or device-specific development tool for a portion of a certain programmable logic device. This portion or sub-array of the programmable logic device may then the “frozen” (e.g. no changes in placement or routing allowed), and made available at the system-level design phases to GEDAE users as if it were a fixed-design IC. This allows the actual performance of the “virtual processing function” provided by the pre-defined sub-array to be predictable and deterministic, just as those characteristics of “real” fixed design components such as coprocessors, graphics accelerators, bus controllers, etc.

Without the use of the invention, only an approximation of the performance of the sub-array design within the system design could be made, because the final, detailed design of the entire programmable logic device's array would necessarily include other functions which would cause variations in placement and routing of the device's internal resources, thus yielding varying performance characteristics of the actual sub-array function. As such, without use of the invention, very long and deep cycles of design steps may be repeated until a final design is achieved, traversing from top-level system design definition through system simulation using the system-level design tool (e.g. GEDAE), continuing through to high-level design of the programmable logic device and simulation (e.g. VHDL design), followed by physical testing, and returning to the system-level design phases for revisions as necessary. Using the invention, these design cycles are partitioned, and cycle depths are minimized (e.g. system level design relies upon fixed deterministic component-level performance characteristic and thus is successful without need to iterate through chip-level design steps).

It will be recognized, though, by those skilled in the art that other design tools and methodologies may benefit from the present invention, and that the scope of the present invention is not limited to the embodiments and details disclosed in the following paragraphs.

Support within GEDAE and other System-Level Design Tools

The present invention allows the system design tool to treat data processors contained within programmable logic arrays such as FPGA's in the same manner as conventional microprocessors for the purposes of high-level design, partitioning of functionality, analysis of performance, and simulation.

As GEDAE provides an environment to assemble, model, partition, map, generate, launch and analyze systems at a system level, using the present invention, FPGA-based data processors can be incorporated into system designs using GEDAE in a relatively elegant manner by treating them in a similar fashion to conventional processors.

In particular, our method provides that a FPGA be treated much like a circuit board of microprocessors, and to provide a host interface much like any conventional processor. This interface is implemented by a command program, which can run on a software “hard core” on the FPGA (e.g. a microprocessor embedded within an FPGA device), or be provided by a conventional processor in the system.

The host interface provides a mechanism for providing programmable sub-array program (e.g. bit-file or “fuse map”) download, an interface to support parameter changes, and a means for collecting debug information from FPGA components.

By treating processors on the FPGA in the same manner as conventional processors, it is also possible to consider the case where more than one function is mapped to an FPGA processor. In practice, mapping a single function to a processor has significant advantages—no schedule is required, and the processor can be optimized to implement a single function. However, there may be circumstances where only highly sequential behavior is required. In this case, the schedule can be implemented by the FPGA processor, in a similar manner as implemented by a time-shared (e.g. task swapped) conventional processor. For such applications, the functionality of the sub-array data processor supports the ability to accept and execute a schedule, which implies a more sophisticated controller be employed, although it should be noted that we already have this sophistication with embedded soft and hard processors, and the work proposed here is focused on simplifying the controller.

A further benefit of taking this approach is that the structure of processors can be derived from the current launch information for static dataflow graph. Dynamic dataflow will introduce control. However, additional outputs from the system-level design tool may be provided to address this problem through modification and enhancement of the tool. This might also be used to address the issue of having to map every FPGA process to a distinct FPGA processor, which can be a bit tedious in a large system.

Realization Using a Core-Based Approach

A core-based methodology provides a foundation for many of the advantages of the present invention. An infrastructure is provided to allow FPGA “cores” to be incorporated into a GEDAE implementation, wherein a core is a data processor design dedicated to a certain programmable logic sub-array which is held static for purposes of system level design and analysis.

Support for custom vector processors is optionally incorporated by allowing compilation of a custom vector processor and its associated program for each core that is not available in the core library. To realize the present invention, the following steps are taken:

1) Define and adopt a core based-methodology;

2) Complete a scalar processor and library;

3) Integrate the scalar processor into core-based methodology;

4) Incrementally develop a custom vector processor;

5) Implement compiler support;

6) Develop library generator; and

7) Integrate vector processors into core-based methodology

The proposed methodology is based primarily upon automatic compilation of functions to vector processors in an FPGA, whose vector length, arithmetic type, wordlength and controller complexity are chosen to match the needs of the desired data processing function. The methodology supports the inclusion of optimized cores for specific functions (i.e. QR, FIR and FFT), and some of these already exist. The elements of the methodology are:

1. Vectorized library code, such as that available from NASoftware of The United Kingdom;

2. Custom Vector Processors, such as those available from QinetiQ of the United Kingdom; and

3. Graphical functional partitioning, mapping, design implementation tool, such as GEDAE.

Vectorized Function Library

The vector processor are preferably programmed using “C” and a modified GCC compiler. A library of vectorized C functions are employed. The vector length employed by these functions is a configurable parameter. This code may be pre-generated for a range of vector lengths, or, more typically, the code is automatically generated for a specific vector length requirement.

Custom Vector Processors

The custom vector processors are assembled from a range of pre-defined components to meet the needs of the functions that the sub-array design will execute. Finite Impulse Repose (“FIR”) and Fast Fourier Transform (“FFT”) functions are described in the following paragraphs.

Design and Implementation Environment

Mapping of functions to processors is preferably achieved using GEDAE. This provides a code generation infrastructure that allows us to manage code generation for a range of different processor types, from conventional processors through to custom vector processors.

Furthermore, GEDAE supports the definition of systems based upon a data-flow model of computation. This exposes the parallelism that exists at a functional level. Thus, the methodology according to the present invention provides two controls over the level of parallelism. Firstly, the number of functions allocated to a processor can be controlled to determine the number of processors employed within the system. Secondly, the vector lengths of the processor each can be chosen to increase the level of parallelism to matched the throughput and latency requirements of the processors within a system.

Trade-off Against Use of Conventional Processors

The vector length in conventional processors is restricted by the input/output bandwidth of the processor. A processor's read and write speed directly affects the data size or precision which can be input to be processed and which can be output as results. This restriction occurs when data is being fetched and stored to memory or being communicated to another processor. If the processors are on the same IC die (e.g. two sub-arrays within the same FPGA), then the communication bandwidth between them can be extremely high. Furthermore, when data is streamed from processor to processor, large buffers are avoided and external memory access is not necessary.

By combining these advantages, large vector lengths are allowed to be used to achieve greater levels of parallelism on a FPGA than can be obtained from a conventional microprocessor, even such powerful microprocessors such as an AltiVec PowerPC.

Additionally, because the clock-rate of an equivalent-functionality FPGA sub-array design is significantly lower, the number of processors that could be integrated on a single programmable logic device can be very high, particularly if those processors are optimized to the task in hand (i.e. low-wordlength integer processing).

The use of a complex data path, which is often required, provides a further, simple, mechanism for increasing parallelism. For example, complex multiply-add functions employ four times the number of operations than a real multiply-add operation. A vector unit that performed complex multiply-add would perform 8 operations per cycle for each complex element of the vector.

Function Support: Datatypes

Two data types are supported in our exemplary embodiment, although others are possible according to application requirements:

(a) floating-point single precision; and

(b) two's complement integer of 8, 16 and 32-bit length.

The wordlength in our exemplary embodiment is specified as a pragma in the C code.

Function Support: Functions

In principle, the function libraries currently provided by NASoftware and Qinetiq, as well as similar function provided by other companies, may be recompiled via a modified C compiler to yield custom vector processors for FPGA subarrays. However, full library support requires a vector processor capable of a wider set of instructions than some of the simpler functions require. Therefore, in some cases, it is appropriate to incrementally extend both the processor and library functionality, a process which will in itself generate a range of custom vector processors. Optimized functions are also preferably provided for FIR, FFT and QRD functions.

Function Support: Summary of Library Functions

In our exemplary embodiment, a library of functions includes the following:

(a) scalar operations;

(b) vector and element wise functions;

(c) signal processing including “FFT+optimised”, Window, “FIR+optimised” Convolution, Correlation, and Histogram;

(d) linear algebra operations including:

(i) Matrix and Vector functions such as matrix product, matrix transpose, general matrix product, general matrix sum, and vector outer product;

(ii) LU decomposition;

(iii) Cholesky factorization;

(iv) QRD+optimised; and

(v) SVD.

Overall Implementation Structure

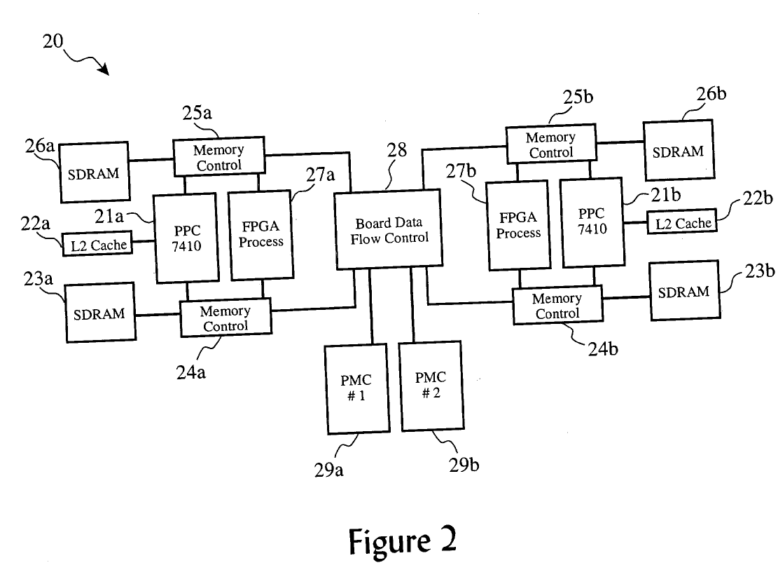

FIG. 2 shows a functional block diagram (20) of the Tera Force Technology “EAGLE” dual-processor circuit board, which is supplied in a 6U VME form factor for industrial and military applications. Each FPGA (27a, 27b) provides computational capability as well as managing the PowerPC (21a, 21b), SDRAM (23a, 23b, 26a, 26b) and PCI data interfaces. Together, the PowerPC (“PPC”) and FPGA processing capabilities provide the user with up to 46 Giga-operations per second of sustained throughput on a single 6U VME board in one embodiment of the EAGLE board.

Each EAGLE board has two 64 bit/66 MHz PCI interfaces (29a, 29b) to the FPGA devices. This allows the board to interface into any PCI Mezzanine Connector (“PMC”) compatible interconnect fabric and I/O. Both PCI buses are connected to both FPGAs. This allows several operational features or advantages:

(a) both PCI buses can be used for input data streams to the same FPGA;

(b) one PCI input data stream may be routed to each of the two FPGAs;

(c) one PCI data stream may be used for input and one for output; or

(d) other combinations of these basic options.

Additionally, each EAGLE board (20) allows up to 1200 Mbytes/Second of data communications between the FPGA (27a, 27b).

Each EAGLE board can have as much as 2 Giga-bytes of SDRAM (23a, 23b, 26a, 26b). Dual SDRAM interfaces allow the FPGAs (27a, 27b) to process data and store it in one SDRAM bank, while the corresponding PowerPC processor processes data sets in the other SDRAM bank controlled by that FPGA. Thus, the board allows 4 simultaneous SDRAM accesses for processing and I/O. The control functions within each FPGA allow its processing core to be inserted in several of the data path combinations suggested in FIG. 2.

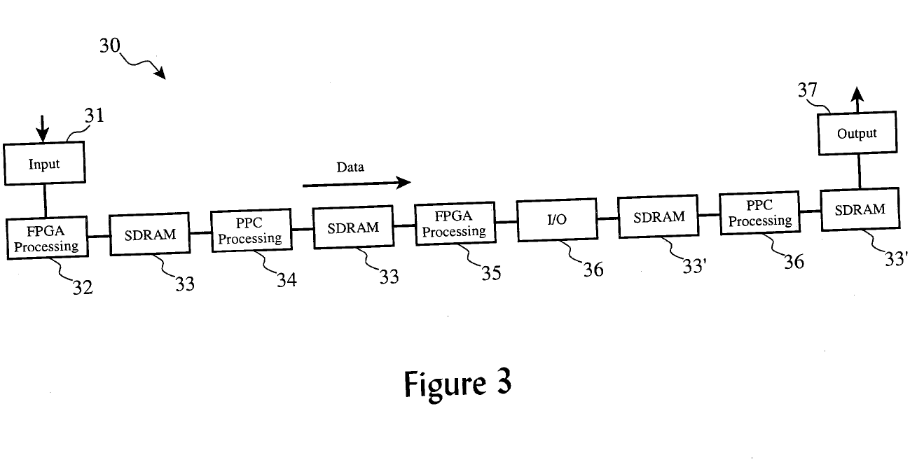

FIG. 3 shows one manner (30) in which the data can be made to flow through the FPGA multiple times to create a useful series processing arrangement. In this example, data flows into (31) one or both of the FPGAs across the PCI bus; passes through one of the FPGA's processing functions (32); and, the results are stored in one of the SDRAM blocks (33). If the next processing step is best handled by the PPC, then a PPC accesses that SDRAM bank, performs (34) its functions, and returns its results to the same SDRAM bank (33).

The next step shown in FIG. 3 is moving data into the FPGA processing core for additional processing (35) and passing the results out (36) of one EAGLE board FPGA and into the other FPGA interface. One method for accomplishing this is using the PCI I/O interface and storing the results in one of the SDRAM banks (33′) connected to the other FPGA on the EAGLE board.

Finally, the PPC connected to the second FPGA performs (36) another set of processes, and stores (33′) those results in SDRAM followed by the results being output (37) from the SDRAM bank through one of the PCI interfaces to that FPGA. The mirror image of that processing stream could also be taking place in the other EAGLE board FPGA and PPC combination.

It should be apparent to those skilled in the art that many other data flow topologies are possible with this set of resources on the EAGLE board, such a parallel paths (e.g. simultaneous processing on the same input data by different processing resources), broadcasting of data (e.g. one-to-many flows), star topologies, rings, feedback paths, etc.

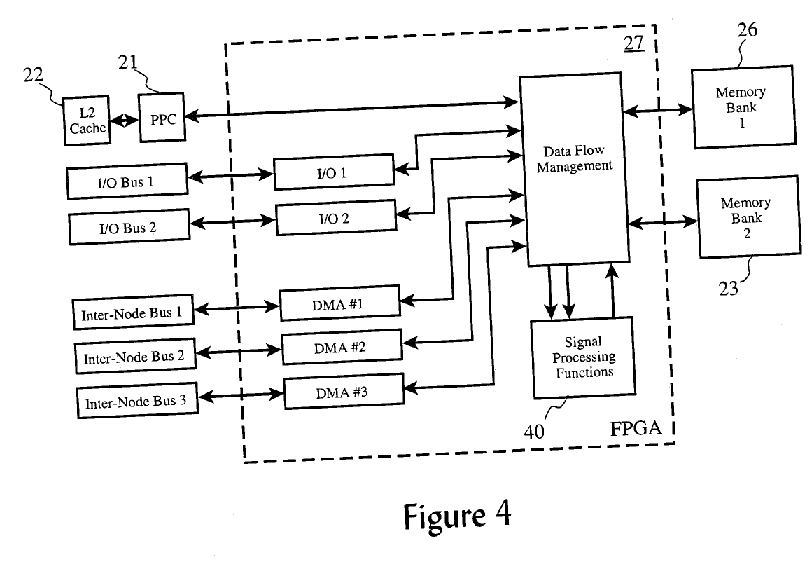

FIG. 4 provides a functional block diagram of each FPGA (27a, 27b) on the EAGLE board, wherein a data flow management function directs data to an from the PowerPC processor (21), the various I/O and InterNode busses, the embedded signal processing functions (40), and the two memory banks (23, 26) for each half of the dual-processor card.

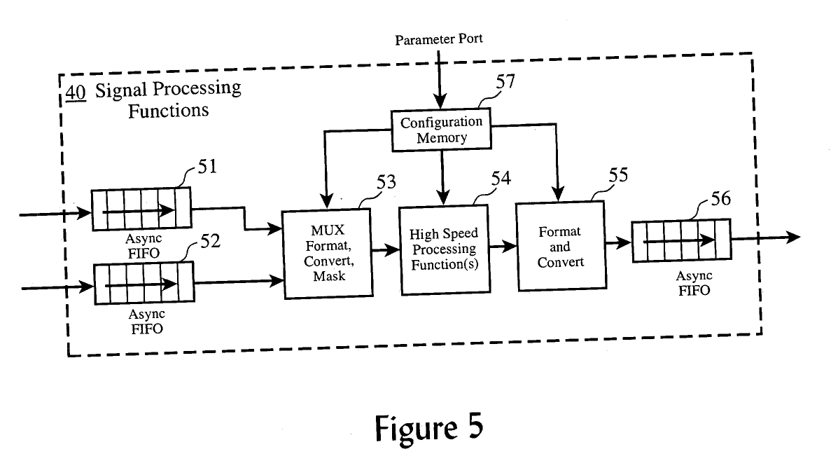

FIG. 5 shows a functional block diagram of the signal processing core (40) inside each FPGA (27a, 27b). Two data streams may be received from the data flow manager and buffered using asynchronous FIFO's (51, 52). The data may then be multiplexed/demultiplexed, formatted, converted (e.g. floating point to fixed point), or masked (e.g. mask off sign bit, mask off least significant bits, etc.) (53). The data is then processed by one or more high speed processing functions (54) such as linear algebra functions, filters, etc., and re-formatted and converted (55) prior to output via an asynchronous FIFO (56). Configuration memory (57) holds processing function parameters, and configuration choices for the formatters (53, 55), which can be loaded by the microprocessor via a parameter port.

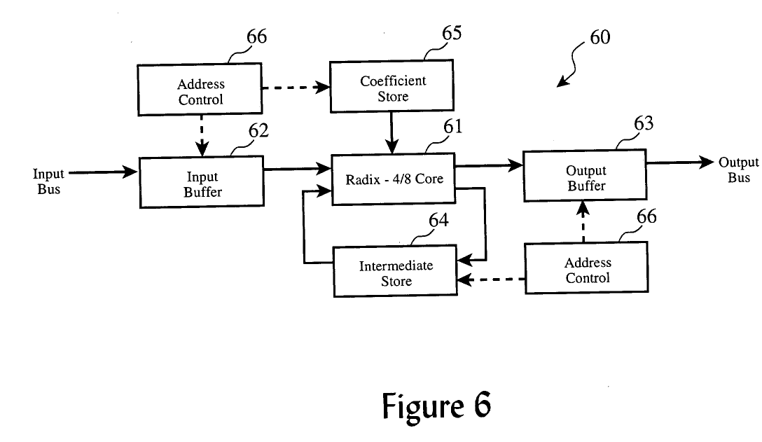

FIG. 6 depicts an example functional block diagram (60) of the FPGA-based FFT processing architecture in which a Radix-4/8 core (61) is used, along with necessary input and output buffers (62, 63), intermediate storage (64), and address control (66).

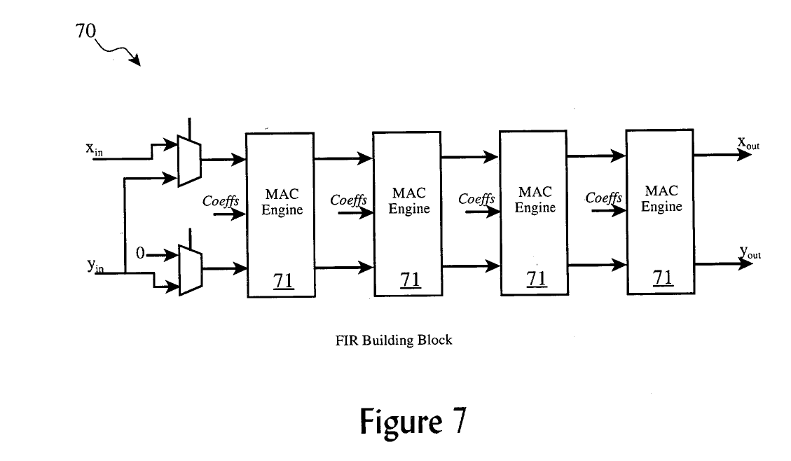

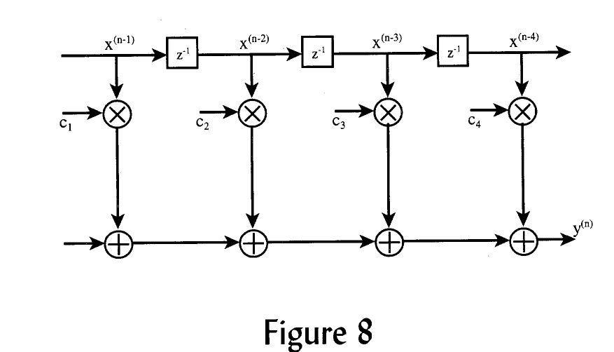

Likewise, FIG. 7 provides an example functional block diagram (70) of the FPGA-based FIR filter processing architecture using multiple Multiply-Accumulate (“MAC”) engines (71) with individual coefficient inputs. FIG. 8 provides more details of such a MAC engine (71).

FPGA FFT Processing Directory Computational Performance

There are three main functions performed by the FFT Directory: FFT/IFFT; Linear filtering in the frequency domain; and, polyphase channelization. In addition, 2-D FFTs can be performed using multiple passes of data through the FGPA core. In fact, operations requiring more than an 4096-point FFT require two passes of the data through the core as those longer lengths are implemented as 2-D decompositions of the 1-D FFT.

The simplest way to characterize the performance of each of these functions is through tables of computation times as a function of the number of complex samples. Example characterization tables are shown in Tables 1, 2, 3 and 4 for each of the FPGAs on a 6U VME EAGLE board for processing times for FFT's, frequency domain filtering, polyphase channelizers, and 2-D FFT's, respectively. Times in Tables 1, 2, 3, and 4 are expressed in microseconds. Note that the tables provide a comparison between FPGA performance of a Xilinx Virtex II XC2V2000-5 clocked at 100 MHz, and the performance of a 500 MHz PowerPC computing these algorithms from L1 cache, L2 cache and SDRAM. In practice, different applications will require the computations to occur using data stored in different places than this example, and as such, these tables are for comparison in this specific scenario.

TABLE 1
Example Comparison of FFT and IFFT Processing Times
for FPGA-based Functions and PPC-executed Functions

| | PPC | PPC | PPC | FPGA |
|---|---|---|---|---|
| Length | L1->L2 | L2->L2 | SDRAM | SDRAM |
| 32 | 0.73 | 0.93 | 1.05 | 0.08 |
| 64 | 1.21 | 1.58 | 2.14 | 0.16 |
| 128 | 2.10 | 2.74 | 4.25 | 0.48 |
| 256 | 4.38 | 5.70 | 8.07 | 0.96 |
| 512 | 8.79 | 12.86 | 17.54 | 1.92 |
| 1024 | 19.47 | 26.17 | 34.37 | 5.12 |
| 2048 | | 60.65 | 85.01 | 10.24 |
| 4096 | | 171.90 | 226.52 | 20.48 |
| 8192 | | 584.74 | 658.89 | 51.20 |
| 16384 | | 1234.82 | 1390.35 | 122.88 |
| 32768 | | 2893.42 | 3091.57 | 245.76 |
| 65536 | | | 5707.04 | 491.52 |

TABLE 2
Frequency Domain Filtering Processing Times

| | PPC | PPC | PPC | FPGA |
|---|---|---|---|---|
| Length | L1->L2 | L2->L2 | SDRAM | SDRAM |
| 32 | 1.92 | 2.61 | 3.43 | 0.16 |
| 64 | 3.33 | 4.66 | 6.93 | 0.32 |
| 128 | 6.03 | 8.48 | 13.81 | 0.96 |
| 256 | 12.41 | 18.91 | 26.76 | 1.92 |
| 512 | 24.88 | 37.73 | 56.31 | 3.84 |
| 1024 | 53.55 | 82.37 | 111.20 | 10.24 |
| 2048 | | 181.36 | 254.95 | 20.48 |
| 4096 | | 439.90 | 622.90 | 40.96 |
| 8192 | | 1361.67 | 1657.49 | 102.40 |
| 16384 | | 2854.02 | 3460.12 | 245.76 |
| 32768 | | 6555.61 | 7541.99 | 491.52 |
| 65536 | | | 14131.78 | 93.03 |

TABLE 3
Polyphase Channelizer Processing Times

| | PPC | PPC | PPC | FPGA |
|---|---|---|---|---|
| Length | L1->L2 | L2->L2 | SDRAM | SDRAM |
| 512 | | 103.99 | 169.47 | 1.92 |
| 1024 | | 195.63 | 338.24 | 5.12 |
| 2048 | | 399.58 | 692.75 | 10.24 |
| 4096 | | 849.76 | 1442.01 | 20.48 |
| 8192 | | 1940.45 | 3089.86 | 51.20 |

TABLE 4
2-D FFT Processing Times

| | PPC | PPC | PPC | FPGA |
|---|---|---|---|---|
| Length | L1->L2 | L2->L2 | SDRAM | SDRAM |
| 32 × 32 | 75.90 | 78.12 | 79.47 | 5.12 |
| 64 × 64 | | 302.08 | 310.46 | 20.48 |
| 128 × 128 | | 1353.64 | 1365.38 | 122.88 |
| 256 × 256 | | 5887.33 | 5948.26 | 491.52 |
| 512 × 512 | | | 31,766.29 | 1966.08 |
| 1024 × 1024 | | | 221,177.65 | 10,485.76 |

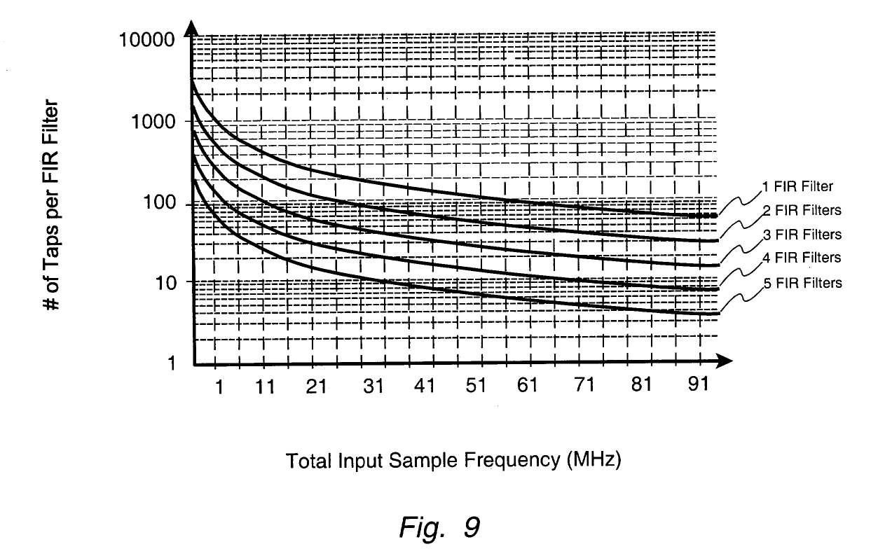

Turning now to FIG. 9, a graph depicting FIR filter performance as a function of the number of parallel real FIR filters implemented and the input sampling frequency is shown.

Heterogenous System Design

The creation of a range of parameterized cores and a communications API provides an infrastructure to rapidly create a heterogeneous implementation combining both programmable logic devices and convention microprocessors. However, for even greater productivity, an environment is required to model, partition and automatically generate the implementation from a library of cores. GEDAE is just such a well-established graphical modeling and auto-code generation environment that can target parallel arrays of conventional processors. It supports a data-flow model of computation that is well matched to sensor array signal processing problems, and maps well onto FPGAs. As such, it presents a good starting-point for a heterogeneous design environment. By utilizing the system and method presented herein, a tool such as GEDAE may be employed to such an end.

As certain details of the preferred embodiment have been described, and particular examples presented for illustration, it will be recognized by those skilled in the art that many substitutions and variations may be made from the disclosed embodiments and details without departing from the spirit and scope of the invention. Therefore, the scope of the invention should be determined by the following claims.

What is claimed is:

1. A method for heterogeneous design and implementation of a complex electronic and software system having one or more static components and one or more programmable logic components, said method comprising the steps of:
providing a first programmable gate array area, said first area having definable function blocks and routable interconnects;
establishing a first program for said first area in which a portion of said first area is dedicated to a first logic design having a first set of functionality and interconnects, and within said first area a second programmable gate array area, said second area having definable function blocks and routable interconnects with resources and constraints formed by said first logic design;
providing a design and analysis tool for use by a user to implement a second logic design within said second area, preventing said user from modifying said first area, and allowing analysis of said second logic design as if it were implemented in a static design component having characteristics and resources as defined and constrained by said first logic design.

2. The method as set forth in claim 1 wherein said step of establishing a first program for a first logic design comprises establishing a digital signal processing framework.

3. The method as set forth in claim 1 wherein said step of establishing constraints and resources for a second programmable gate area comprises defining a collection of pre-defined primitive functions.

4. The method as set forth in claim 1 wherein said step of providing a design and analysis tool comprises providing a graphical system design tool.

5. The method as set forth in claim 4 wherein said step of providing a graphical system design tool comprises providing a GEDAE tool.

6. The method as set forth in claim 1 wherein said step of providing a design and analysis tool comprises providing a high level language tool.

7. The method as set forth in claim 6 wherein said step of providing a high level language tool comprises providing a VHDL design tool.

8. A computer readable medium encoded with software for heterogeneous design and implementation of a complex electronic and software system having one or more static components and one or more programmable logic components, said software performing the steps of:
providing a first programmable gate array area, said first area having definable function blocks and routable interconnects;
establishing a first program for said first area in which a portion of said first area is dedicated to a first logic design having a first set of functionality and interconnects, and within said first area a second programmable gate array area, said second area having definable function blocks and routable interconnects with resources and constraints formed by said first logic design;
providing a design and analysis tool for use by a user to implement a second logic design within said second area, preventing said user from modifying said first area, and allowing analysis of said second logic design as if it were implemented in a static design component having characteristics and resources as defined and constrained by said first logic design.

9. The computer readable medium as set forth in claim 8 wherein said software for establishing a first program for a first logic design comprises software for establishing a digital signal processing framework.

10. The computer readable medium as set forth in claim 8 wherein said software for establishing constraints and resources for a second programmable gate area comprises software for defining a collection of pre-defined primitive functions.

11. The computer readable medium as set forth in claim 8 wherein said software for providing a design and analysis tool comprises software for providing a graphical system design tool.

12. The computer readable medium as set forth in claim 11 wherein said software for providing a graphical system design tool comprises software for providing a GEDAE tool.

13. The computer readable medium as set forth in claim 8 wherein said software for providing a design and analysis tool comprises software for providing a high level language tool.

14. The computer readable medium as set forth in claim 13 wherein said software for providing a high level language tool comprises software for providing a VHDL design tool.

15. A system for heterogeneous design and implementation of a complex electronic and software system having one or more static components and one or more programmable logic components, said system comprising:
a first programmable gate array area, said first area having definable function blocks and routable interconnects;
a first program for said first area in which a portion of said first area is dedicated to a first logic design having a first set of functionality and interconnects, and within said first area a second programmable gate array area, said second area having definable function blocks and routable interconnects with resources and constraints formed by said first logic design;
a design and analysis tool for use by a user to implement a second logic design within said second area, configured to prevent said user from modifying said first area, and allowing analysis of said second logic design as if it were implemented in a static design component having characteristics and resources as defined and constrained by said first logic design.

16. The system as set forth in claim 15 wherein said a first program for a first logic design comprises a digital signal processing framework.

17. The system as set forth in claim 15 wherein said constraints and resources for a second programmable gate area comprises a collection of pre-defined primitive functions.

18. The system as set forth in claim 15 wherein said design and analysis tool comprises a graphical system design tool.

19. The system as set forth in claim 18 wherein said graphical system design tool comprises a GEDAE tool.

20. The system as set forth in claim 15 wherein said design and analysis tool comprises providing a high level language tool.

21. The system as set forth in claim 20 wherein said high level language tool comprises a VHDL design tool.
